(19) United States
(12) Patent Application Publication
(10) Pub. No.: US 2010/0310889 A1
(43) Pub. Date: Dec. 9, 2010

(54) Non-Impact Printing Process and Articles Thereof

(76) Inventors: Paul Amaat Raymond Gerard France, West Chester, OH (US); Edmond Irizarry, Cincinnati, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/478,917

(22) Filed: Jun. 5, 2009

(51) Int. Cl. B32B 9/06; B32B 29/00; B32B 27/00; B32B 37/02

(52) U.S. Cl. 428/486; 428/537.5; 428/500; 156/230

(57) ABSTRACT

A label for marking a surface comprising: a) a support portion, b) a varnish in at least partial contact with the support portion, c) a primer in at least partial contact with the varnish, d) an ink in at least partial contact with the primer, and e) an optional adhesive in at least partial contact with the ink, wherein the label is capable of being at least partially affixed to the surface by at least heating the label.

### BACKGROUND OF THE INVENTION

Heat transfer labels have been known in the art for some time. These labels have been used to mark various containers, bottles, packages, and the like. In the heat-transfer labeling process, a label-carrying web may subjected to heat, and the label pressed onto an article with the ink design layer making direct contact with the article. As the label-carrying web is subjected to heat, the wax layer begins to melt. This enables the paper sheet to be released from the ink design layer, with a portion of the wax layer being transferred with the ink design layer onto the article and a portion of the wax layer remaining with the paper sheet. After transfer of the design to the article, the paper sheet may be removed, leaving the design affixed to the article and the wax transferred therewith exposed to the environment. The heat-transfer label may further include an adhesive layer (comprising, for example, a polyamide or polyester adhesive) deposited over the ink design to facilitate adhesion of the label onto the surface and/or a protective lacquer layer interposed between the wax release layer and the ink layer.

Various types of label printing process have been utilized to make a heat transfer label. Various printing methods, including gravure printing, screen printing, and flexographic printing, have been utilized. However, there is an inability with each of these processes to change or alter the printed material quickly. These methods require difficult setup in order to produce a label, and even more setup if there is a mistake or a change is needed. Given the flexibility needed by business today, the downtime needed for this type of printing results in high expense that must either be recouped by the consumer or written off by the business.

There exist a need for a printing process and an article made from such a printing process that is capable of being made quickly. There further exists a need for such a label to be able to be printed out utilizing a digital process, where images and/or text can be changed quickly. This invention fills those needs.

### SUMMARY OF THE INVENTION

In one embodiment, the current invention relates to a label for marking a surface comprising: a) a support portion, b) a varnish in at least partial contact with the support portion, c) a primer in at least partial contact with the varnish, d) an ink in at least partial contact with the primer, and e) an optional adhesive in at least partial contact with the ink, wherein the label is capable of being at least partially affixed to the surface by at least heating the label.

In an alternate embodiment, the current invention relates to a process for marking a surface comprising a) providing a label capable of being attached to the surface, said label comprising: 1) a support portion, 2) a varnish in at least partial contact with the support portion, 3) a primer in at least partial contact with the varnish, 4) an ink in at least partial contact with the primer, and 5) an adhesive in at least partial contact with the primer; b) placing the label in contact with the surface, c) heating the label to at least partially affix the label onto the surface, and d) removing the support portion from the label.

### BRIEF DESCRIPTION OF THE DRAWING

FIG. 1 illustrates the process of making the label of the current invention.

### DETAILED DESCRIPTION OF THE INVENTION

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While the specification concludes with the claims particularly pointing and distinctly claiming the invention, it is believed that the present invention will be better understood from the following description.

The devices, apparatuses, methods, components, and/or compositions of the present invention can include, consist essentially of, or consist of, the components of the present invention as well as other ingredients described herein. As used herein, “consisting essentially of” means that the devices, apparatuses, methods, components, and/or compositions may include additional ingredients, but only if the additional ingredients do not materially alter the basic and novel characteristics of the claimed devices, apparatuses, methods, components, and/or compositions.

All percentages and ratios used herein are by weight of the total composition and all measurements made are at 25° C., unless otherwise designated. A degree is a planar unit of angular measure equal in magnitude to 1/360 of a complete revolution.

All measurements used herein are in metric units unless otherwise specified.

The current invention relates to a label for marking a surface comprising: a support portion, a varnish in at least partial contact with the support portion, a primer in at least partial contact with the varnish, an ink in at least partial contact with the primer, and an optional adhesive in at least partial contact with the ink, wherein the label is capable of being at least partially affixed to the surface by heating the label. The current invention also relates to a process for marking a surface comprising providing a label capable of being attached to the surface, said label comprising: a support portion, a varnish in at least partial contact with the support portion, a primer in at least partial contact with the varnish, an ink in at least partial contact with the primer, and an adhesive in at least partial contact with the primer; placing the label in contact with the surface, heating the label to at least partially affix the label onto the surface, and removing the support portion from the label.

Without wishing to be bound by theory, it is believed that a digital printing process can be used to print labels of this manner in combination with analog coating processes. Digital printing processes, such as utilizing the HP Indigo type of printer, have historically been problematic when used with labels of the present invention, as the printing would smear, run, or not have the necessary durability. Other problems utilizing digital printing include achieve the proper surface energy in the transfer medium in order to enhance the printed image to be transferred from a transfer drum of the digital printer onto the label. By incorporating a primer layer within the label structure, the adhesion of the inks onto the label is improved, resulting in improved durability of the layers while enhancing the digital printing process.

### Digital Printing

In one embodiment, the current invention utilizes a digital printing process. Digital printing processes include any processes for adding ink to the label that are computer manipulated. Technologies for accomplishing this manipulation include inkjet printing, laser printing, electroink printing and the like. In one embodiment, the digital printing utilized within this invention is non-impact printing.

Printing technologies, which do not require a stable, physical, fixed image carrier and can generate in principle a different printed image per print, are referred to as non-impact printing. Electrophotographic technology is one embodiment of non-impact printing technologies. A laser sends information to an intermediate carrier, a drum with a photoconductive coating without impact. The latent charged image stored on this drum is inked with a toner and transferred to the substrate. There is of course contact between the inked (toned) information carrier and the substrate during printing but the information is not transferred by impact. The predominating technologies are electrophotography and ink jet printing. Ionography, magnetography and thermography are also used for non-impact printing. Unlike printing methods that use a fixed image carrier, these non-impact printing technologies can create a completely different print image rotation by rotation, thus it is not necessary to generate a mechanical master for each printed image. Non-impact printing technologies allow for print on demand and personalization or customization. Further technical descriptions of these Non-impact Printing technologies are be found in Handbook of Print Media, edited by Helmut Kipphan ISBN3-540-67326-1 Springer-Verlag Berlin (2001), the entirety of which is incorporated by reference.

An exemplary device capable of digital printing is the HP® Indigo series of printing presses. HP® Indigo printing presses rely upon electro transfer of liquid ink, transferring the final image from a make-ready blanket in one pass on the varnish of the label. The blanket is negatively charged to a nominal value of about 800 volts. A coding unit transfers data from the artwork file directly to the blanket by reducing the printing areas to about −100 volts, the ink with a voltage rating of about −400V is attracted to the low voltage areas of the blanket. The colors are added sequentially in a step and repeat motion.

### Process for Coating Substrate

The layers of the present invention are coated by one or more analog coating processes. By analog coating process, it is meant to differentiate these processes from the digital printing utilized to apply inks to the label. Exemplary analog coating processes include flood coating and spot coating. Flood Coating is a well-known technique within the print industry to apply coatings and layers of the present invention. During the flood coating process, the coating substance is applied via nozzles to the substrate as it passes by. The excess substance is then scrapped by doctor blades and re-circulated, after filtration. Spot Coating is also a well-known technique whereby coatings and layers can be applied to only a portion of the current invention. Spot coating typically allows for greater control of registration and layer thickness. Spot coating can be applied using conventional analog print methods such as gravure, flexoprinting or screen printing.

Flood coating and spot coating are used in various embodiments for applying the adhesive, varnish, primer, and substrate coating to the substrate of the present invention to form the label of the present invention. Any combination of flood and spot coating may be used in the various coating steps of the present invention to achieve the desired results. In one embodiment, the primer is spot coated substantially in areas where the digital printing process is applying ink.

The various processes for forming the label can be accomplished in a continuous, batch, or mixed (continuous and batch) manner. In a non-limiting example, forming the support portion in one embodiment occurs in a continuous process. The support portion is then stored until the rest of the label is ready to be made, at which point additional steps are performed, as disclosed herein, to form a label in a second continuous process.

It is also contemplated that various surface treatments, pre-print coating treatments, and post-print coating treatments, post-print coating treatments known in the art can be utilized with this invention. Exemplary treatments include heating processes, cooling processes, corona treatment, surface polishing, and the like.

### Support Portion

The support portion of the invention includes at least one substrate and at least one coating. Suitable substrates include any material capable of fixing the label components for an indefinite period of time in predetermined arrangements. Substrates include papers, non-wovens, plastics, woven materials, and the like. Plastic substrates include polyesters, such as polyethylene terephthalate, polyethylene napthylene; polyolefins, such as polyethylene and polypropylene; and polyamides. In one embodiment, the support portion is a clear plastic film. In another embodiment, the support portion is a translucent plastic film. Opaque films are also contemplated. In one embodiment, the substrate is contained on a roll whereby the substrate is fed from the roll in at least a semi-continuous manner. In another embodiment, the substrate is provided in discreet sizings, such as a 10 cm by 10 cm substrate, to facilitate label formation.

The support portion of this invention also comprises a substrate coating. Without wishing to be bound by theory, it is believed that the substrate coating when heated aids the release of the substrate from the rest of the label as the label is applied to a surface. Any substrate coating that would facilitate such a function is contemplated. Such coatings include waxes, paraffins, silicones, polyethylene, and the like. In one embodiment, the coating has a thickness of about 0.01 to 10 microns, in an alternate embodiment from about 0.02 microns to about 1 micron.

### Varnish

In one embodiment, a varnish or lacquer layer is at least partially positioned between the support portion and the primer. In one embodiment, the varnish is at least partially positioned between the coating and the primer. Varnishes, such as phenoxy varnishes described in U.S. Pat. No. 5,800,656, or cross-linked phenoxy varnishes described in U.S. patent application Ser. No. 09/093,150, are contemplated. Without wishing to be bound by theory, it is believed that the varnish layer protects the label after it has been placed on a surface by improving resistance to scratching, scuffing, and the like.

In one embodiment, aesthetic modifying agents are at least partially mixed with the varnish. Aesthetic modifying agents modify the final label by providing additional visual, tactile, or scent elements to the label. Aesthetic modifying agents providing additional visual elements include glitter, pearlescent additives, tinting agents, and the like. Aesthetic modifying agents providing additional tactile elements include tackifiers, grits and sands, and the like. Aesthetic modifying agents providing additional scent elements include perfumes, perfume microcapsules, and the like.

In one embodiment, the varnish is added to the label at a thickness from about 1.0 micron to about 2 microns.

### Primer

In the digital printing process of the current invention, at least a portion of the varnish coated with a primer, to ensure proper ink transfer and adhesion to the substrate. In one embodiment, the primer has a thickness of from about 0.1 to about 2.0 gram per square meter of substrate. In one embodiment, the primer is pre-mixed in the varnish. Suitable primer compositions can also be found in U.S. Pat. Nos. 6,767,588; 6,743,480 and 7,014,974. Exemplary primers include acrylic based monomers. Moreover, an exemplary primer is polyethylenimine (PEI).

A thin substantially uniform coating of the primer can be applied to the label of the present invention using a gravure printing process, although other coating processes, as known in the art may be used. The primer adheres well to the plastic and the primer coated surface can be printed with liquid toners, such as for example those described in U.S. Pat. No. 5,407,771 to Landa et al., the disclosure of which is incorporated herein by reference. Toners are ElectroInk® produced and sold by Indigo N. V. of the Netherlands such as ElectroInk® EI-Mark 3.0 and EI-Mark 3.1 are suitable. Other toners can be used.

Other components for forming a primer include a dispersed phase of Styrofan, Acronal 866 or Styronal D808. Styrofan and Styronal are trade names for aqueous polymer dispersions based on styrene-butadiene sold by BASF. Acronal is a trade name for acrylate homopolymers and copolymers in dispersed form sold by BASF. For these materials, aqueous dispersion is by weight, preferably, 8%±4% of a dispersed phase of Styrofan, Acronal 866 or Styronal D808. As in the case for dispersion formed with MP4990, dispersion formed with Styrofan, Acronal and Styronal is preferably mixed with 6% polyethylenimine solution in equal parts by weight of dispersion to solution. A quantity of dispersion based on Styrofan, Acronal or Styronal may be mixed with a quantity of polyethylenimine solution to provide a primer in which the ratio of dispersed phase of Styrofan, Acronal or Styronal to polyethylenimine in the primer has a range between 1 and 5, in accordance with one embodiment of the present invention. Other components, including water, non-aqueous solvents, surfactants, rheology modifiers and the like can be combined with the primer of the present invention. It should be noted that the above method for preparing a primer in accordance with a preferred embodiment of the present invention is given by way of example. Other methods known in the art for combining materials to prepare the primer may be used.

Other primers suitable for use with the current invention are listed in 6,767,588, 6,743,480; 7,014,974, the disclosures of which are incorporated by reference. Exemplary primers include DigiPrime® (water based primer made by Michelman); and Saphire® (solvent based primer made Indigo Electronic Printing Systems Ltd.)

### Ink

Inks of the current invention may actually comprise either a single ink layer or a plurality of ink layers. Inks of the present invention may be made using one or more conventional inks, such as polyester inks, polyester/vinyl inks, polyamide inks and/or acrylic inks. One of ordinary skill will readily know that there is a plethora of inks that can be utilized and can utilize these inks based on the needs for the label. Inks formed from both dyes, pigments, and combinations thereof are also contemplated. In one embodiment, the inks of the present invention are compatible for use with digital printing.

### Adhesive

In one embodiment, the adhesive of the current invention comprises a heat-activatable adhesive, a pressure-activatable adhesive, or a heat/pressure activatable adhesive. Exemplary adhesives include polyester-based adhesives; however, other types of adhesives, such as water-based acrylic adhesives (see, for example, U.S. Ser. No. 09/093,153, which application is incorporated herein by reference), phenoxy adhesives (see for example, U.S. Ser. No. 09/189,277, which application is incorporated herein by reference) and the like, are also suitable. In one embodiment, the adhesive layer is formed by depositing, by gravure printing or the like, onto (i) ink layer 25, (ii) exposed portions of primer layer (iii) and/or exposed portions of the varnish layer.

### EXAMPLE

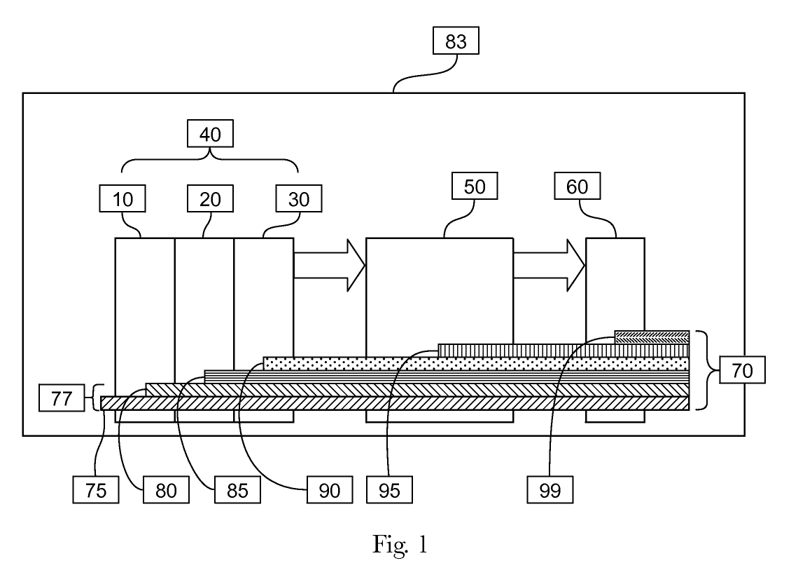

FIG. 1 illustrates the label 70 of the present invention. The present invention relates to a hybrid system 83 that marries the knowledge of analog coating process with the flexibility of digital printing. In this embodiment, the label is produced by a combination of a pre-print coating treatment 40, a digital printing 50 and a post-print coating treatment 60.

During the pre-print coating treatment 40 the substrate 75 is first coated with at least one substrate coating 80 during a substrate coating process 10 forming the support portion 77. The substrate 75 may be coated in multiple layers of the same or different substrate coating 80.

After the substrate 75 has been coated with at least one substrate coating, a varnish 85 is coated over the substrate coating 80 in a varnish coating process 20. Next, a primer 90 is coated over the varnish 85 during a primer coating process 30.

Upon completion of the primer coating process 90, ink 95 is printed onto the primer 90 in the desired patterns and forms during the Digital Print Process 50. After the printing of the ink 95, an adhesive layer 99 may optionally be applied during a finish coating process 60. Further treatments of the label 70 during and/or after the post-print coating treatment 60 include corona treatments and the like.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

It should be understood that every maximum numerical limitation given throughout this specification will include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A label for marking a surface comprising:
a) a support portion,
b) a varnish in at least partial contact with the support portion,
c) a primer in at least partial contact with the varnish,
d) an ink in at least partial contact with the primer, and
e) an optional adhesive in at least partial contact with the ink
wherein the label is capable of being at least partially affixed to the surface by at least heating the label.

2. The label of claim 1, wherein the varnish and primer are mixed together before being contacted with the support portion.

3. The label of claim 1, wherein the support portion comprises a substrate and at least one substrate coating.

4. The label of claim 3, wherein the varnish, primer, and substrate coating are mixed together before being contacted with the support portion.

5. The label of claim 1, wherein the substrate comprises papers, non-wovens, plastics, woven materials, or combinations thereof.

6. The label of claim 1, wherein the at least one substrate coating comprises wax, paraffin, silicone, polyethylene or combinations thereof.

7. The label of claim 1, wherein the varnish comprises a phenoxy varnish.

8. The label of claim 1, wherein the varnish comprises one or more aesthetic modifying agents.

9. The label of claim 1, wherein the one or more aesthetic modifying agents comprise glitter, pearlescent additives, and tinting agents.

10. The label of claim 1, wherein the primer comprises polyethylenimine.

11. The label of claim 1, wherein the primer comprises an acrylic based monomer

12. The label of claim 1, wherein the ink is applied over substantially all of the primer layer.

13. The label of claim 1, the label is capable of being at least partially affixed to the surface by applying pressure to the label while the label is in partial contact with the surface.

14. A process for marking a surface comprising
a) providing a label capable of being attached to the surface, said label comprising:
1) a support portion,
2) a varnish in at least partial contact with the support portion,
3) a primer in at least partial contact with the varnish,
4) an ink in at least partial contact with the primer, and
5) an adhesive in at least partial contact with the primer
b) placing the label in contact with the surface
c) heating the label to at least partially affix the label onto the surface
d) removing the support portion from the label.

15. The process of claim 14, wherein steps a-d occur in a continuous process.

16. The process of claim 14, wherein steps a-d occur in a batch process.

17. The process of claim 14, wherein steps 1-4 occur in a continuous process.

18. The process of claim 14, wherein steps 2, 3 and 5 occur in an analog coating process

19. The process of claim 14, wherein step 4 occurs in a digital printing process
